(19) United States
(12) Patent Application Publication
(10) Pub. No.: US 2026/0347662 A1
(43) Pub. Date: Nov. 5, 2026

(54) METHOD FOR PRODUCING A HONEYCOMB PLATE

(71) Applicant: Henkel AG & Co. KGaA, Düsseldorf (DE)

(72) Inventor: Sebastian Mailaender, Paderborn (DE)

(21) Appl. No.: 19/706,000

(22) Filed: Jun. 12, 2026

Related U.S. Application Data
(63) Continuation of application No. PCT/EP2024/083509, filed on Nov. 26, 2024.

(30) Foreign Application Priority Data
Dec. 20, 2023 (EP) 23218435.8

(51) Int. Cl. C09J 5/06

(52) U.S. Cl. CPC C09J 5/06; C09J 2400/166; C09J 2400/286

(57) ABSTRACT

The invention is directed to a method for producing a honeycomb plate. The honeycomb plate comprises a first cover layer (1) and a second cover layer (2) and a core element (3) arranged between the first cover layer (1) and the second cover layer (2), wherein the core element (3) has a honeycomb structure with cells (5) delimited by connection pieces (4) and wherein the core element (3) has a first surface (6) which bears against the first cover layer (1) and a second surface (7) which bears against the second cover layer (2).

### FIELD OF THE INVENTION

The invention relates to a method for producing a honeycomb plate.

### BACKGROUND OF THE INVENTION

A sandwich plate with a honeycomb core, or honeycomb plate for short, refers to a mostly three-layer composite structure in which a core element is arranged between two outer cover layers and has a honeycomb structure formed by a plurality of connection pieces with usually hexagonal cells. Such honeycomb plates can, for example, be made entirely of paper-based materials, but they can also comprise plastics or aluminum. In particular, the cover layers can also be made of a different material than the core element. For example, the cover layers can be made of thin wooden panels, whereas the core element is made of paper or cardboard.

Due to their special structure, honeycomb plates have high mechanical rigidity while being lightweight. They are therefore particularly suitable for use in the furniture industry, but they are also used, for example, in aircraft, ship and automobile construction or as facade elements.

Such honeycomb plates are usually produced by bonding the core element to the cover layers. A suitable adhesive, for example in liquid form as a polyurethane or dispersion adhesive or as a meltable film, is applied over the entire surface of the cover layers and the core element is inserted between the cover layers. In order to achieve good adhesion between the core element and the cover layers, it is necessary to press the composite together for an extended period of time during the drying process.

A disadvantage of the uniform and full-surface application of adhesive is that a large part of the adhesive remains unused on the cover layers in the opening regions of the cells, since the bond between the cover layers and the core element occurs only in the region of the connection pieces forming the honeycomb structure. At the same time, the connection pieces form only very narrow contact regions.

DE 10 2006 060 940 B4 describes a development of such a method for producing a lightweight panel. In this case, an adhesive is first applied to the surface of a cover layer over the entire surface or in the form of droplets and/or strips and the core element is then placed on the cover layer provided with adhesive. In order to distribute the applied adhesive in such a way that it is less concentrated in the opening regions of the cells and more concentrated in the region of the connection pieces of the core element, DE 10 2006 060 940 B4 proposes carrying out a relative movement between the cover layer provided with adhesive and the core element placed thereon. The relative movement can, for example, be a translational movement or a rotational movement or a combination of a translational and a rotational movement. In any case, the frictional relative movement redistributes a certain proportion of the liquid adhesive so that it concentrates primarily in the region of the connection pieces of the core element, thereby improving adhesion between the core element and the cover layer.

However, this method is relatively complex. In addition, adhesive components remain in regions of the cover layer where no connection pieces of the core element are located, with the result that these adhesive components do not contribute to the bond. In the interest of resource-efficient use of materials, this is considered to be in need of improvement.

### SUMMARY OF THE INVENTION

The object of the present invention is therefore to provide an efficient method for producing a honeycomb plate, which is associated with a lower consumption of adhesive and at the same time creates a particularly good bond between the core element and the two cover layers.

This object is achieved by a method having the features of claim 1.

Advantageous embodiments and developments of the invention are the subject matter of the dependent claims.

### DETAILED DESCRIPTION OF THE INVENTION

In accordance with claim 1, the invention relates to a method for producing a honeycomb plate, wherein the honeycomb plate comprises a first cover layer and a second cover layer and a core element arranged between the first cover layer and the second cover layer, wherein the core element has a honeycomb structure with cells delimited by connection pieces and wherein the core element has a first surface which bears against the first cover layer and a second surface which bears against the second cover layer, said method comprising the following steps:
i) providing the core element and the first and second cover layer;
ii) spraying a hot-melt adhesive onto at least one surface of the core element, the hot-melt adhesive being stretched during spraying such that a mesh-like adhesive structure is formed on the at least one surface of the core element;
iii) heating the at least one surface of the core element provided with hot-melt adhesive and thereby reactivating the hot-melt adhesive;
iv) pressing a cover layer onto the at least one surface of the core element provided with hot-melt adhesive;
v) optionally carrying out method steps ii) to iv) for the second surface of the core element and the second cover layer such that the core element is arranged between the two cover layers.

In other words, according to the invention the adhesive is not applied to the cover layers, as is known from the prior art, but the surfaces of the core element are provided with adhesive. To this end, the method according to the invention proposes spraying a hot-melt adhesive onto at least one surface of the core element, the hot-melt adhesive being stretched during spraying such that a mesh-like adhesive structure is formed on the at least one surface of the core element. The stretching of the adhesive can be achieved by using a special nozzle through which the adhesive is sprayed onto the surface of the core element contactlessly and under pressure. The adhesive threads created in this way form a mesh-like structure on the surface of the core element, i.e., they lie on the connection pieces and span the opening regions of the cells.

By heating the at least one surface of the core element provided with hot-melt adhesive in a subsequent method step according to the invention, the pre-stretched hot-melt adhesive is reactivated. The invention makes use of the knowledge that the mesh structure created by the adhesive dissolves during reactivation and the adhesive retracts toward the connection pieces of the honeycomb structure. As a result, there is no longer any adhesive in the opening regions of the cells; instead, the adhesive is concentrated exclusively in the region of the connection pieces of the honeycomb structure. The adhesive also adheres to lateral regions of the connection pieces, such that when a cover layer is subsequently placed or pressed onto the core element, a particularly good bond can be produced between the cover layer and the core element due to the particularly high adhesive concentration in the region of the connection pieces. The cover layer must be pressed on within the open time of the hot-melt adhesive. The open time refers to the period of time within which an adhesive can form an adhesive bond before it subsequently re-solidifies. The method according to the invention thus makes it possible to provide a local concentration of adhesive in a simple manner precisely in those regions of the honeycomb structure that actually contribute to the bond. Investigations on honeycomb plates produced using the method according to the invention show that the adhesive remains in the region of the connection pieces even after the core element and cover layers have been joined together and, to a certain extent, encloses them, such that larger contact regions are formed between the core element and cover layers compared with conventional joining methods.

Since no adhesive components remain unused in the opening regions of the cells, the amount of adhesive applied can be reduced overall compared with methods known from the prior art. This makes the method according to the invention particularly resource-efficient. At the same time, the advantage of hot-melt adhesive over water-based adhesives applied as liquid is that handling strength is reached within a few seconds, since the heat is dissipated very quickly via the cover layer. This eliminates the need for energy-and time-consuming drying processes that would otherwise be required, and the formed component can immediately undergo further processing.

In principle, in the method according to the invention, initially only the first surface of the core element can be provided with hot-melt adhesive in the manner described above. This surface can then be heated and the first cover layer can be pressed on. The above-mentioned method steps can then be carried out analogously for the second surface of the core element and the second cover layer. Alternatively, the first and the second surface of the core element can be provided with hot-melt adhesive simultaneously or immediately one after the other. Subsequently, the two surfaces can be heated simultaneously or immediately one after the other and the first cover layer can be pressed onto the first surface and the second cover layer can be pressed onto the second surface of the core element. In principle, there can be a specific period of time between the method step of spraying the adhesive and that of reactivating the adhesive by heating, during which the solidified adhesive mesh structure remains on the honeycomb plate. This period of time can range from a few seconds to several hours.

In accordance with a preferred embodiment of the invention, the hot-melt adhesive can be sprayed onto the surfaces of the core element by spin spraying using a compressed-air-operated spiral nozzle. In this case, the adhesive is expelled through a central nozzle, with compressed-air channels being additionally arranged in a spiral around the nozzle. By blowing in air, the adhesive is stretched and the emerging adhesive threads are set into rotation. The adhesive threads catch on the connection pieces and spread in the manner of a spider's web over the entire honeycomb structure of the core element. In principle, other nozzles can also be used that allow the hot-melt adhesive to be applied to the core element in a contactless and stretched manner.

The hot-melt adhesive can be sprayed at an angle a of 30° to 60° with respect to the surface of the core element. For example, the hot-melt adhesive can be sprayed at an angle of approximately 45° with respect to the surface of the core element.

For example, a thermoplastic hot-melt adhesive can be used as a hot-melt adhesive. Alternatively, a reactive hot-melt adhesive can be used. When using a reactive hot-melt adhesive, the solidified adhesive can be reactivated using hot steam. This can further accelerate the subsequent crosslinking. Reactive polyurethane-based hot-melt adhesives react with ambient humidity after application, which means that bonds of this kind have greater heat resistance because they do not re-melt. This can be accelerated by introducing moisture when the adhesive is reactivated.

Depending on the hot-melt adhesive used, the application temperature of the adhesive can range between approximately 120 °C and 210 °C. In principle, hot-melt adhesives have the property of solidifying immediately upon cooling after application. This creates a solidified adhesive mesh on the surface of the core element, where the mesh can in principle remain for an extended period of time, for example for several hours, before subsequent method steps are carried out.

According to one embodiment of the invention, the at least one surface of the core element provided with adhesive is heated by hot air and/or by hot steam and/or by infrared radiation. In general, it is necessary to heat the pre-stretched hot-melt adhesive above its softening point to initiate the desired reactivation. This can be achieved extremely well by using hot air and/or hot steam and/or infrared radiation. The use of infrared radiation is particularly advantageous when the hot-melt adhesive comprises an admixture of an infrared-reactive additive. This can shorten reaction times even further.

According to one embodiment of the invention, the hot-melt adhesive is sprayed onto the core element at a weight per unit area of 30 to 90 g/m². For example, the hot-melt adhesive can be sprayed onto the core element at a weight per unit area of 60 g/m². It has been shown that such an amount of adhesive is sufficient to achieve the desired strength of the bond when applying the method according to the invention. In contrast, in methods known from the prior art, in which a dispersion adhesive is applied to the cover layers over the entire surface or at least in strips, adhesive quantities of 120 g/m² and more are required to achieve a reliable bond. For honeycomb plates made of aluminum, adhesive consumption is even higher in methods known from the prior art, in which liquid polyurethane adhesives are usually applied to the cover layers at a weight per unit area of approximately 250 g/m². Since the method according to the invention can provide a local concentration of adhesive precisely in those regions of the honeycomb structure that actually contribute to the bond, the application quantities of adhesive can be significantly reduced.

In accordance with one embodiment, the core element comprises a paper-based material. For example, the core element can be made of thin cardboard. The cover layers can also be made of a paper-based material. However, they can also be made of wood, such as MDF board. Such honeycomb plates are particularly suitable for use in furniture construction and interior design.

Alternatively, the core element may comprise an aluminum-based material. The cover layers can also be made of aluminum sheets. Preferred fields of application for honeycomb plates made of aluminum are, in particular, construction, transportation and shipbuilding.

In principle, a plurality of material combinations are possible in the formation of honeycomb plates and the method according to the invention is suitable for efficient and resource-efficient production of such honeycomb plates, regardless of the specific materials.

In the following, the invention is explained in more detail by means of an exemplary embodiment and with reference to the attached drawings. In the drawings:

FIG. 1 shows the method step of spraying a hot-melt adhesive onto a surface of the core element;

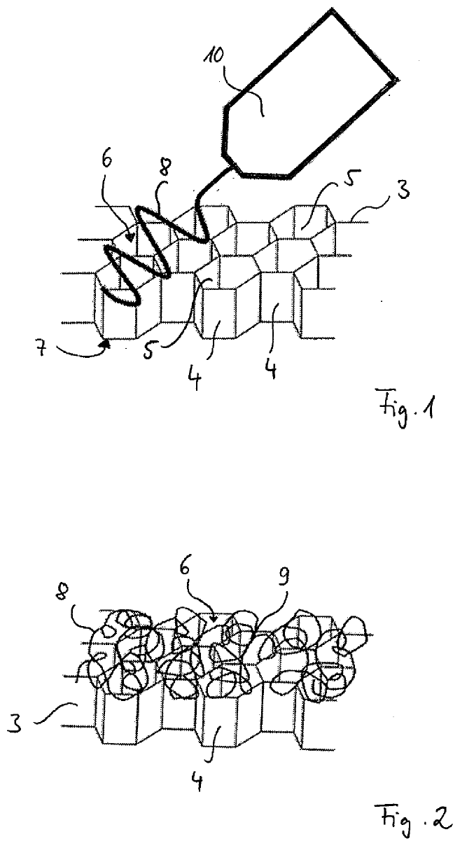

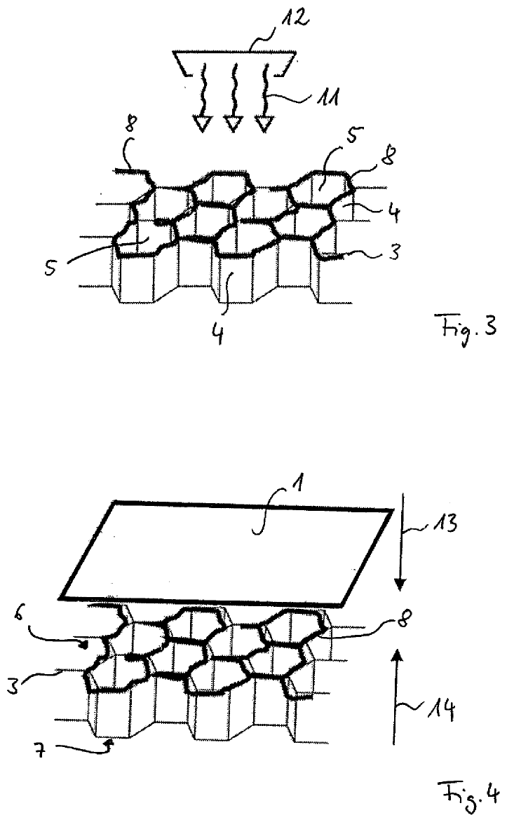

FIG. 2 shows a mesh-like adhesive structure formed on the surface of the core element;

FIG. 3 shows the method step of heating the surface of the core element provided with adhesive;

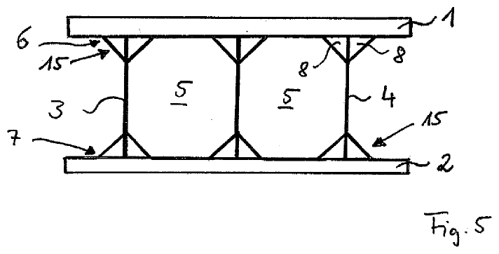

FIG. 4 shows the method step of pressing the cover layer onto the surface of the core element provided with adhesive;

FIG. 5 is a sectional view of a honeycomb plate produced by the method according to the invention.

In a first method step, a core element 3 and a first cover layer 1 and a second cover layer 2 are provided. FIG. 1 shows a core element 3 made of a paper-based material; the two cover layers 1, 2 are not shown in FIG. 1. The core element 3 has a honeycomb structure with hexagonal cells 5 delimited by connection pieces 4. In the illustration of FIG. 1, a first surface 6 of the core element 3 is oriented upward, whereas a second surface 7 of the core element is oriented downward.

FIG. 1 shows the method step of spraying a hot-melt adhesive 8 onto the first surface 6 of the core element 3. The hot-melt adhesive 8 is a reactive hot-melt adhesive. The hot-melt adhesive 8 is sprayed at an angle a of approximately 45° with respect to the surface 6 of the core element 3 using a compressed-air-operated spiral nozzle 10 (shown only schematically). In this case, the hot-melt adhesive is expelled through a central nozzle, with compressed-air channels being arranged in a spiral around the nozzle. By blowing in air, the adhesive is stretched and the emerging adhesive threads are set into rotation. The adhesive threads catch on the connection pieces 4 of the honeycomb structure and lay over the opening regions of the cells 5. The nozzle 10 is guided over the surface 6 of the core element 3 in such a way that a dense, mesh-like adhesive structure 9 is formed on the first surface 6 of the core element 3. This state is shown in FIG. 2. The hot-melt adhesive 8 is applied at a weight per unit area of approximately 60 g/m².

In a subsequent method step, shown schematically in FIG. 3, the first surface 6 of the core element 3 provided with hot-melt adhesive 8 is heated. Heating is carried out using hot air 11 from a hot air source 12. Heating reactivates the stretched hot-melt adhesive 8. In the process, the mesh-like adhesive structure 9 produced in the previous method step dissolves and the hot-melt adhesive 8 retracts toward the connection pieces 4 of the honeycomb structure. As a result, there is no longer any hot-melt adhesive 8 in the opening regions of the cells 5, but rather the hot-melt adhesive 8 is concentrated exclusively in the region of the connection pieces 4 of the honeycomb structure. This state is shown in FIG. 3.

In a subsequent method step, as shown in FIG. 4, the first cover layer 1, in this case in the form of a thin MDF board, is placed in a direction indicated by the arrow 13 onto the first surface 6 of the core element 3 provided with hot-melt adhesive 8 and lightly pressed on. Since the reactivated hot-melt adhesive 8, as will be explained in more detail below in connection with FIG. 5, also adheres to lateral regions of the connection pieces 4, the locally particularly high adhesive concentration in the region of the connection pieces 4 produces a particularly good bond between the cover layer 1 and the core element 3. The cover layer 1 must be pressed on within the open time of the hot-melt adhesive 8. Since the introduced heat is dissipated very quickly via the first cover layer 1, the hot-melt adhesive 8 solidifies immediately and further time- and energy-consuming drying processes can be dispensed with.

In an analogous manner, by repeating the described method steps, the second cover layer 2 (not shown here) is also connected to the second surface 7 (facing downward here) of the core element 3. For this purpose, hot-melt adhesive 8 is sprayed onto the second surface 7 of the core element 3 in the manner described above, so that a mesh-like adhesive structure is formed. Subsequently, the second surface 7 is heated by means of hot steam 11 so that the hot-melt adhesive 8 is reactivated and retracts toward the connection pieces 4 in the manner described above. The second cover layer 2 can then be pressed onto the second surface 7 of the core element 3 in a direction indicated by the arrow 14, so that the core element 3 is finally arranged between the two cover layers 1, 2.

FIG. 5 is a sectional view of a section of a honeycomb plate produced by the method according to the invention. It can be clearly seen here that the hot-melt adhesive 8 retracts toward the connection pieces 4 of the core element 3 and, in particular, also adheres to lateral regions of the connection pieces 4 and, to a certain extent, encloses them, such that overall enlarged contact regions 15 are formed in the region of the connection pieces 4.

The method according to the invention thus makes it possible to provide a local concentration of adhesive in a simple manner precisely in those regions of the honeycomb structure that actually contribute to the bond. Compared to conventional joining methods, larger contact regions are formed between the core element 3 and the cover layers 1, 2, such that a better bond between the core element 3 and the cover layers 1, 2 can be achieved with an overall reduced use of adhesive.

Furthermore, the method according to the invention is characterized in that a honeycomb plate produced by this method can immediately undergo further processing, since time- and energy-consuming drying processes can be dispensed with due to the short reaction times of the hot-melt adhesive 8. The method according to the invention is particularly suitable for producing honeycomb plates for the furniture industry and for producing lightweight aluminum panels.

1. A method for producing a honeycomb plate, wherein the honeycomb plate comprises a first cover layer (1) and a second cover layer (2) and a core element (3) arranged between the first cover layer (1) and the second cover layer (2), wherein the core element (3) has a honeycomb structure with cells (5) delimited by connection pieces (4) and wherein the core element (3) has a first surface (6) which bears against the first cover layer (1) and a second surface (7) which bears against the second cover layer (2), said method comprising the following steps:
i) providing the core element (3) and the first and second cover layer (1, 2);
ii) spraying a hot-melt adhesive (8) onto at least one surface (6, 7) of the core element (3), the hot-melt adhesive (8) being stretched during spraying such that a mesh-like adhesive structure (9) is formed on the at least one surface (6, 7) of the core element (3);
iii) heating the at least one surface (6, 7) of the core element (3) provided with hot-melt adhesive (8) and thereby reactivating the hot-melt adhesive (8);
iv) pressing a cover layer (1, 2) onto the at least one surface (6, 7) of the core element (3) provided with hot-melt adhesive (8);
v) optionally carrying out method steps ii) to iv) for the second surface (7) of the core element (3) and the second cover layer (2) such that the core element (3) is arranged between the two cover layers (1, 2).

2. The method according to claim 1, wherein the hot-melt adhesive (8) is applied to the surfaces (6, 7) of the core element (3) by spin spraying using a compressed-air-operated spiral nozzle (10).

3. The method according to claim 1, wherein the hot-melt adhesive (8) is sprayed at an angle α of approximately 45°, with respect to the surfaces (6, 7) of the core element (3).

4. The method according to claim 1, wherein the hot-melt adhesive (8) is a reactive hot-melt adhesive.

5. The method according to claim 1, wherein the at least one surface (6, 7) of the core element (3) provided with hot-melt adhesive (8) is heated by hot air, hot steam (11), and/or infrared radiation.

6. The method according to claim 1, wherein the hot-melt adhesive (8) is sprayed onto the surfaces (6, 7) of the core element (3) at a weight per unit area of 30 to 90 g/m².

7. The method according to claim 1, wherein the core element (3) comprises a paper-based material.

8. The method according to claim 1, wherein the core element (3) comprises an aluminum-based material.
